(19) United States
(12) Patent Application Publication
(10) Pub. No.: US 2022/0383271 A1
(43) Pub. Date: Dec. 1, 2022

(54) SELECTING REMEDIATION FACILITIES

(71) Applicant: Hewlett-Packard Development Company, L.P., Spring, TX (US)

(72) Inventors: Ankeeta Sawant, Pune (IN); Abhishek Jangid, Pune (IN); Narendra Kumar Chincholikar, Pune (IN)

(21) Appl. No.: 17/683,586

(22) Filed: Mar. 1, 2022

(30) Foreign Application Priority Data
Jan. 14, 2021 (IN) 202141001848

(51) Int. Cl. G06Q 10/00; G06Q 30/00

(52) U.S. Cl. CPC G06Q 10/20; G06Q 30/016

(57) ABSTRACT

Examples are described herein for selecting remediation facilities. In various examples, data associated with a data processing device may be processed using a trained machine learning model. The data may be collected from multiple sources associated with the data processing device. Based on the processing, a deficiency may be inferred that is, or is likely to be, exhibited by a component of the data processing device. Based on the inferred deficiency, a location of the data processing device, and locations of a plurality of candidate remediation facilities, a given remediation facility of the plurality of candidate remediation facilities may be selected to remediate the deficiency.

### BACKGROUND

Data processing devices such as laptop computers, smart phones, tablet computers, etc., as well as their constituent components, may malfunction, fail, or otherwise exhibit deficiencies for innumerable reasons. These incidents may cause users of the data processing devices to submit service requests in which each user describes a problem they are experiencing and requests remediation. The average time to respond to these service requests may be referred to as the mean time to repair (MTTR). If the MTTR is too great, frustrated users may seek new data processing devices from elsewhere.

### BRIEF DESCRIPTION OF THE DRAWINGS

Features of the present disclosure are illustrated by way of example and not limited in the following figure(s), in which like numerals indicate like elements.

FIG. 1 schematically depicts an example environment in which selected aspects of the present disclosure may be implemented.

FIG. 2 schematically demonstrates an example of how data may be processed by various components to practice selected aspects of the present disclosure, in accordance with various examples.

FIG. 3 depicts an example of how natural language processing may be employed to practice selected aspects of the present disclosure, in accordance with various examples.

FIG. 4 depicts an example method for practicing selected aspects of the present disclosure, in accordance with various examples.

FIG. 5 shows a schematic representation of a system, according to an example of the present disclosure.

FIG. 6 shows a schematic representation of a non-transitory computer-readable medium, according to an example of the present disclosure.

### DETAILED DESCRIPTION

MTTR may be exacerbated by various factors, such as a remediation facility (also referred to herein as a “service center”) that responds to a service request lacking sufficient expertise and/or inventory. Accordingly, examples are described herein for selecting remediation facilities from a plurality of remediation facilities for various purposes related to decreasing MTTR, such as (i) preemptive distribution of components such as replacement parts to the plurality of remediation facilities, and/or (ii) responding to service requests (received from a user and/or predicted to be received). This may ensure that if and when data processing devices fail or otherwise exhibit deficiencies, those data processing devices can be serviced as quickly and competently as possible, thereby reducing MTTR.

Remediation facilities may be selected for preemptive distribution of components based on a variety of factors, many related to logistics. For example, a prediction may be made that for a particular model of data processing device, a particular component (e.g., a battery) is likely to fail in the near future. Locations of data processing devices of that model may be identified, e.g., from position coordinates provided by the data processing devices themselves and/or information provided by end users, e.g., when registering the data processing devices. These data processing device locations may be compared to locations of multiple remediation facilities to select those remediation facilities that are most proximate to data processing devices predicted to fail—and therefore are able to respond to those predicted failures more quickly. Those selected remediation facilities may have their inventories preemptively stocked with replacement components and/or tools for remediating the predicted failures.

In some examples, these remediation facilities may also be selected based on experience and/or expertise (“expertise” as used herein captures both) of personnel at each remediation facility, e.g., to increase a likelihood that someone at the facility will be able to respond to a predicted service request promptly and competently. In various examples, expertise may be represented quantitatively using a numeric measure of expertise, a ranking (e.g., beginner, intermediate, expert), a number of hours working on the same/similar issues or in the same domain, etc. In some instances, even if a particular remediation facility is most proximate to a number of data processing devices predicted to fail, if that remediation facility lacks sufficient expertise to address the failure, another remediation facility that is less proximate may be selected (or, suitable personnel from another remediation facility may be transferred proactively to the most proximate facility).

Remediation facilities may be selected for responding to service requests—whether received from end users or predicted—based on factors similar to those discussed above. For example, the location of a data processing device exhibiting a deficiency may be compared to locations of a plurality of candidate remediation facilities to identify those that are most proximate, and hence, may be able to respond more quickly. In addition, expertise and/or component inventory at each remediation facility may be considered. If the most proximate facility with an applicable replacement component lacks expertise on the data processing device deficiency that triggered the service request, another, more remote remediation facility that has both the applicable replacement component and sufficient expertise may be selected instead.

Data processing device deficiencies may be predicted ahead of time—whether for preemptively stocking inventory of remediation facilities or for proactively selecting remediation facilities to respond to predicted service requests—based on various sources of data. Data may be obtained from data processing devices themselves, e.g., passively, that can be used to predict malfunctions and/or other deficiencies of the data processing devices and/or their constituent components. Additionally, when a number of user-submitted service requests are received that relate to the same problem, then predictions may be made that other similarly-configured data processing devices are likely to experience the same issues.

Various types of machine learning models may be employed in various examples for a variety of purposes. In some implementations, natural language text provided by a user as part of a service request (e.g., speech recognized from a telephonic service request or submitted via a service request webpage) may be processed, e.g., using machine learning-based natural language processing techniques, so that the service request can be classified into one of a plurality of classifications. For example, a text classifier machine learning model (e.g., a neural network) may be trained to predict a category of such text based on features that are extracted from that text, and that were “learned” by the model during training, e.g., from labeled training sets of historic service requests. Once a service request is classified in this manner, the classification may be considered, e.g., in combination with other factors such as relative locations of the data processing and remediation facilities, expertise at various remediation facilities, etc., to select remediation facilities as described herein.

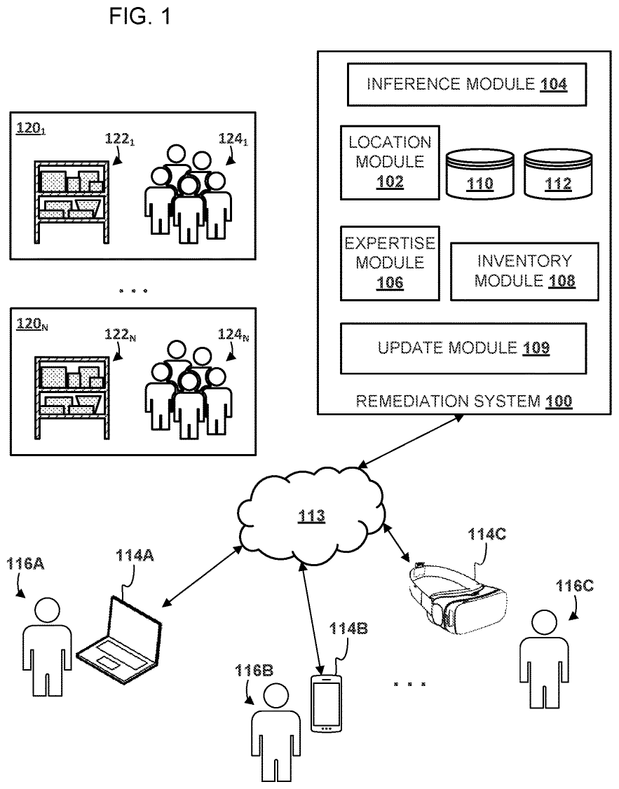

FIG. 1 schematically depicts an example environment in which selected aspects of the present disclosure may be implemented. A remediation system 100 may be implemented using computer system(s) such as computer server(s) that in some cases may form what is often referred to as a “cloud infrastructure” or simply the “cloud.” Remediation system 100 may include various elements that are to practice selected aspects of the present disclosure to select a remediation facility 120 from a plurality of remediation facilities 120_{1-N} for various purposes related to decreasing MTTR.

A plurality of data processing devices 114A-C are depicted in FIG. 1 as being operated by a corresponding plurality of users 116A-C, and are communicatively coupled with remediation system 100 via wired and/or wireless computer network(s) 113 such as the Internet and/or local area network(s). Three data processing devices 114A-C are depicted in FIG. 1, but it should be understood that any number of data processing devices 114 may be managed using techniques described herein. A first data processing device 114A takes the form of a laptop computer. A second data processing device 114B takes the form of a tablet computer or smart phone. A third data processing device takes the form of a head-mounted display that provides an augmented reality (AR) and/or virtual reality (VR) experience for third user 116C. Other types of data processing devices, such as desktop computers, vehicular computer systems, set top boxes, ambient computer systems, etc., are also contemplated.

Remediation system 100 includes a location module 102, an inference module 104, an expertise module 106, an inventory module 108, and an update module 109. Any of modules 102, 104, 106, 108, and 109 may be implemented using any combination of hardware and computer-executable instructions. For example, any of modules 102, 104, 106, 108, and 109 may be implemented using a processor that executes instructions stored in memory, a field-programmable gate array (FPGA), and/or an application-specific integrated circuit (ASIC). Any of modules 102, 104, 106, 108, and 109 may also be combined with others of modules 102, 104, 106, 108, and 109, may be omitted, etc.

Remediation system 100 also includes a first database 110 that stores data associated with machine learning model(s) (e.g., weights, parameters, etc.) that are used to practice selected aspects of the present disclosure. Remediation system 100 also includes an informational database 112 that stores data gathered by location module 102, expertise module 106, and/or inventor module 108. Although depicted separately, in some examples, databases 110 and 112 may be implemented as part of a single database.

Location module 102 may obtain, and store in database 112, locations of data processing devices 114 and of remediation facilities 120_{1-N}. In some examples, location module 102 may also analyze relative locations of data processing devices 114 and remediation facilities 120 to determine (e.g., as one factor in a multi-factor analysis) which remediation facilities 120 are best suited to remediate deficiencies in data processing devices 114.

Each remediation facility 120 may include inventory 122 and personnel 124. Inventory 122 at a given remediation facility 120 may include on-hand, in stock, or otherwise available components associated with remediating deficiencies in data processing devices 114, such as replacement parts (e.g., batteries, network cards, memory chips, etc.), tools for fixing deficiencies in data processing devices, parts for upgrading and/or updating data processing devices 114, etc. Inventory module 108 may track inventories 122_{1-N} of remediation facilities 120_{1-N} and store this inventory data in database 112. In some examples, inventory module 108 may also select, alone or in conjunction with other modules such as expertise module 106, remediation facilities 120 that are suitable for receiving additional inventory (e.g., proactively in response to predicted deficiencies in data processing devices 114) and/or for responding to service requests from users 116.

Personnel 124_{1-N} at remediation facilities 120_{1-N} may include employees, contractors, or other people that are available to help address deficiencies with data processing devices 114, e.g., whether at the request of users 116 or automatically based on data provided automatically/periodically by data processing devices 114 themselves. Expertise module 106 may track and/or quantify measures of expertise (e.g., training, experience) of personnel 124_{1-N} across remediation facilities 120_{1-N} and store that data in database 112. For example, each individual of personnel 124 may be assigned a numeric measure(s) of expertise based on their experience, training, proficiency, efficiency, etc. in particular areas of expertise, such as batteries, other hardware, operating systems, etc. In some examples these measures of expertise may be determined based on feedback from users, e.g., about how well a particular individual was able to remediate a deficiency in a data processing device 114.

In some examples, expertise module 106 may leverage these measures of expertise to select, alone or in conjunction with other modules such as inventory module 108, a remediation facility 120 for various purposes. For example, measure(s) of expertise of personnel 124 at a particular remediation facility 120 may result in that facility 120 being proactively supplied with additional inventory. In another implementation, measure(s) of expertise of personnel 124 at a particular remediation facility 120 may result in that facility 120 being selected for responding to service requests from users 116, even if other, less proficient remediation facilities are closer to the data processing device 114 at issue.

Inference module 104 may process various data from various sources using machine learning model(s) from database 110 to make various inferences. These inferences may be leveraged to perform selected aspects of the present disclosure, particularly for reducing MTTR and increasing customer satisfaction. In some examples, inference module 104 may process data associated with a particular data processing device 114 using a trained machine learning model. This data may be collected from multiple sources associated with the particular data processing device 114. For example, a user 116 may submit a service request about a deficiency of his or her data processing device 114 using various modalities, such as via telephone, online chat, email, text message, webpage submission, etc. As another example, the data processing device 114 itself may provide various data about its health (hereinafter “device health data”), e.g., periodically, continuously, on demand, etc.

Device health data may take numerous forms related to hardware and/or computer-executable instructions (sometimes referred to as “software”). In some examples, device health data may include, for instance, device type, device manufacturer, device model, operating system (including version, release, etc.), product stock-keeping unit (SKU), data about memory/processor, location (e.g., country, region), data about the device's basic input/output system (BIOS) or Unified Extensible Firmware Interface (UEFI) such as version, release data, latest version, etc., battery data (e.g., recall status, current health, serial number, warranty status), data about past errors/failures (e.g., date occurred, bug check code, driver/version, bug check parameters, etc.), firmware information, warranty information, peripheral information (e.g., display, docking station), drivers, software updates applied/available, uptime, performance metrics, and so forth.

By processing this data from various sources, in some examples, inference module 104 infers a deficiency that is, or is likely to be, exhibited by a component of the data processing device 114. Based on the inferred deficiency, as well as a location of the data processing device 114 and locations of a plurality of candidate remediation facilities 120_{1-N}, various components of remediation system 100 may cooperate to select a given remediation facility of the plurality of candidate remediation facilities 120_{1-N} to remediate the deficiency. For example, the closest remediation facility 120 with adequate inventory 122 and personnel 124 with sufficient expertise may be selected, even if a less-suitable remediation facility is actually closer to the deficient data processing device 114.

If the deficiency is predicted in the future, then the selected remediation facility 120 may be proactively provided with components such as replacement parts and/or tools to address the deficiency. If the deficiency has already occurred, then the selected remediation facility 120 may be selected to respond to the deficiency, e.g., by shipping the user 116 a replacement part, talking the user 116 through remediating the deficiency, repairing the data processing device 114, etc.

Some deficiencies, whether predicted in the future or presently-observed, may be addressed without needing to fix or swap out hardware. For example, many deficiencies may be handled most effectively by updating executable instructions (e.g., software, firmware) on a data processing device 114. The executable instructions can include an operating system, various applications that execute on top of the operating system, device drivers that operate with the operating system to control peripheral devices, etc. In any case, and based on an inference from inference module 104, update module 109 may provide automatic executable instruction updates, upgrades, patches, and/or fixes of remote data processing devices 114_{1-M}, e.g., by pushing out updates or patches

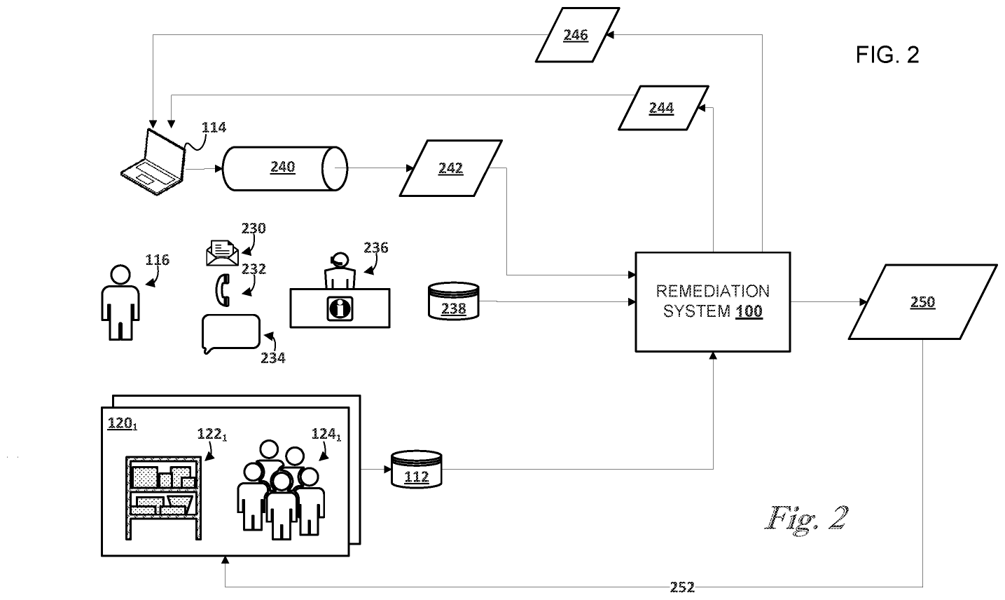

FIG. 2 schematically demonstrates an example of how data may be processed by various components to practice selected aspects of the present disclosure, in accordance with various examples. In this example, a user 116 may communicate with helpdesk personnel 236 (which may or may not be associated with a particular remediation facility 120) to convey a deficiency in a data processing device 114 (laptop in FIG. 2) operated by user 116. There may be multiple different modalities available for user 116 to communicate with helpdesk personnel 236, including but not limited to via electronic correspondence 230 such as email, telephone 232, and/or online chat 234, to name a few. Other modalities may include, but are not limited to, service request websites, proprietary applications operating on data processing device 114 (which in some cases may also provide device health data), video calls, and so forth.

In various implementations, information about a deficiency in data processing device 114 that us conveyed by user 116 to helpdesk personnel 236 may be stored in a database 238. In instances where user 116 conveys the information orally (e.g., over the telephone 232 or video call), speech recognition processing may be performed on an audio recording of the user's speech to generate, and store in database 238, speech recognition textual output. As shown in FIG. 2, information in database 238 may be available to, and used by, remediation system 100 to perform selected aspects of the present disclosure.

Meanwhile, a plurality of remediation facilities 1201-N (bottom left in FIG. 2) may store information about their respective inventories 122 and personnel 124 (including measure(s) of expertise) in database 112 as described previously. As will be described below and as is shown in FIG. 2, information stored in database 112 may be available to, and used by, remediation system 100 to make various decisions about which remediation facility 120 should be selected to remediate a deficiency in data processing device 114.

Data processing device 114 itself also provides device health data to remediation system 100. In FIG. 2, data processing device 114 provides device health data to an analytics pipeline 240, which in various examples may be implemented on the same computing system(s) as remediation system 100, or may be implemented elsewhere, such as wholly or partially on data processing device 114 itself. Data analytics pipeline 240 may process the device health in various ways, such as computing statistics, aggregating data, imputing missing data points, cleaning data, etc., such that preprocessed device health data 242 can be provided to remediation system 100 in a suitable form.

Based on a service request provided by user 116 via modalities 230-234, as well as preprocessed device health data 242 and information about remediation facilities 120_{1-N} stored in database 112, remediation system 100 may infer a deficiency exhibited by a component of data processing device 114. In some examples, remediation system 100 may process the service request information provided by user 116 using a trained machine learning model to generate output. Based on this output, as well as on device health data 242, remediation system 100 in general, and inference module 104 in particular, may infer the deficiency. Based on the inferred deficiency, a location of data processing device 114, and locations of candidate remediation facilities 120_{1-N}, remediation system 100, e.g., by way of location module 102, may select a given remediation facility 120 to remediate the deficiency.

If the service request provided by user 116 is accurate and complete—e.g., because user 116 has sufficient expertise to accurately diagnose the problem with data processing device 114—this process may be relatively straightforward. However, may deficiencies in data processing devices may not be so easily diagnosed, especially where user 116 lacks sufficient expertise. In some cases, user 116 may actually misdiagnose the problem, and may, for instance, select an incorrect menu item as characterizing the problem. However, remediation system 100 may be able to override such an incorrect diagnosis.

For example, in some implementations, inference module 104 may perform natural language processing (NLP) on natural language in the service request provided by user 116 to assign the service request one of a plurality of classifications (the given remediation facility may be selected based in part on the assigned classification). These classifications can vary widely, and can be associated with hardware or computer-executable instructions. Some non-limiting examples may include “battery failure,” “disk failure,” “motherboard failure,” “application failure,” “operating system failure,” “device driver failure,” and so forth. In some implementations, inference module 104 may also use device health data 242 to make these classifications. If a classification of the problem provided explicitly by user 116 is incorrect, in some examples, remediation system 100 may override that classification provided by user 116 with the assigned (e.g., inferred) classification.

Remediation system 100 may perform various actions in response to the service request provided by user 116, as well as to the inference(s) made based on this service request by inference module 104. In various examples, remediation system 100 may generate a support ticket 250, which may or may not be in electronic form. Support ticket 250 may specify what action (if any) should be taken by which entity. In some cases, support ticket 250 may be provided to both user 116 and the remediation facility 120 (e.g., at 252) that is selected to remediate the deficiency in data processing device 114.

For example, remediation system 100 may make a recommendation 246 that is presented as output on data processing device 114 (or another data processing device if data processing device 114 is unable). This recommendation 246 may, for instance, instruct user 116 to provide data processing device 114 to the closest remediation facility 120 (e.g., in person if sufficiently proximate, via post or pickup if not) that has sufficient inventory and expertise to address the deficiency. If the deficiency with data processing device 114 is based in computer-executable instructions, then remediation system 100 may, in some examples, provide a software update 244 (e.g., a patch, new release, driver update, etc.) to be installed on data processing device 114 to remediate the deficiency.

Inference module 104 may employ various types of machine learning models to diagnose deficiencies and/or to classify service requests provided by users into discrete classifications/domains. For example, various types of neural networks or other regression models may be applied to various data points (e.g., device health 242) to predict future deficiencies and/or to diagnose existing deficiencies. Neural Networks have the ability to learn via training and to produce output that is not limited to input provided to them. Neural networks can learn from examples and apply them when a similar event arises, making the neural networks able to work through real-time events. Even if a neuron is not responding or a piece of information is missing, the neural network can detect the fault and still produce output. Some neural networks can perform multiple tasks in parallel without affecting the system performance. Neural networks may be capable of learning from faults, thereby increasing their capacities to make accurate inferences/predictions.

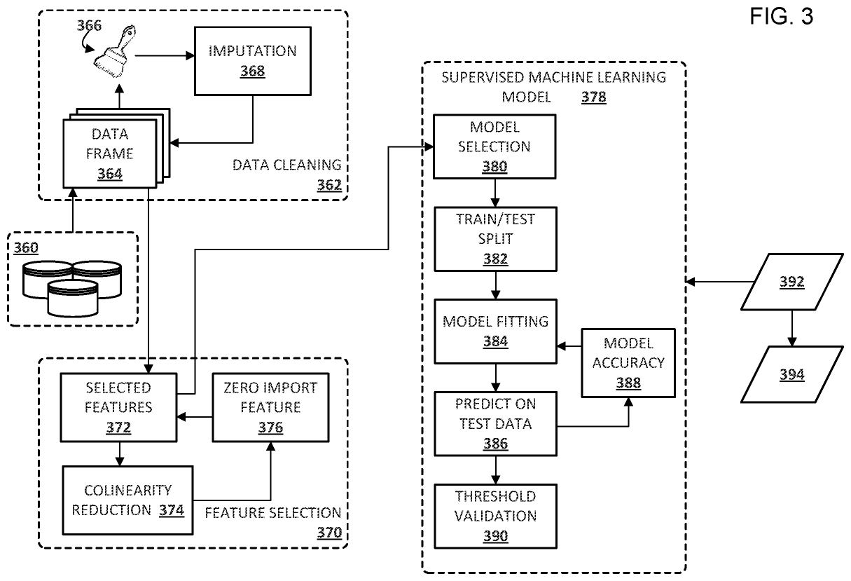

FIG. 3 depicts an example of how NLP may be employed to classify service requests, in accordance with various examples. Data 360 associated with historic data processing device deficiencies may include, for instance, labeled service requests (which may include speech-recognized text where applicable). In a data cleaning stage 362, these data may be organized into frames 364 (e.g., associated with each deficiency). Each frame 364 may be cleaned at 366, e.g., to remove outliers, duplicate words, words having more than some number of characters (e.g., fifteen), convert all text to lower case, remove newlines and extra spaces, remove special characters or information (e.g., personally identifiable information (PII) and payment card industry (PCI) data), etc. At block 368, invalid data points such as nulls, missing data points, etc., may be imputed (e.g., based on averages, zeros, etc.).

The “cleaned” data frames 364 may next be subjected to a feature selection stage 370. At block 372, various features considered to be relevant or probative to diagnosing and/or remediating deficiencies may be selected. At block 374, collinearity reduction may be performed on the selected features. At block 376, zero importance features may be eliminated (e.g., replaced with zeroes, discarded). These zero importance features may include, for instance, boilerplate, disclaimers, greetings, signatures, etc.

The selected features (once processed at blocks 374-376), which may still be organized into frames, may then be provided to a supervised machine learning model training stage 378. In some implementations, the selected features may first be encoded into feature vectors (e.g., embeddings) prior to be subjected to training stage 378. At block 380, a particular machine learning model, such as a neural network, may be selected. The frames of selected features may be split into training data (e.g., 80% of the data) used to train the model and testing data (e.g., 20% of the data) to gauge the model's performance.

Model fitting may be performed at block 384, and may include techniques such as gradient descent, back propagation, etc. The trained model may be used at block 386 to process the testing data to make predictions/inferences. At block 388, an accuracy of the model may be determined, e.g., using performance metrics such as the F1 score. The F1 score is based on two metrics, precision and recall, that dictate what fraction of the predictions/inferences are correct and which fraction of correct known values are predicted. For example: if the model classifies ten service requests as “Hardware Issues” where eight of the service requests are truly hardware issues while the total number of known hardware issues in the labeled dataset is twelve, then precision=8/10 (0.8) and recall=10/12 (0.83). Hence, the F1 score would be 2P*R/(P+R)=0.814. In some examples, a confusion matrix may be employed to examine specific cases where the model performs poorly.

At block 390, threshold validation may include comparing the performance of the model with a threshold. If the threshold is satisfied, then the model may be deemed sufficiently accurate to make real world predictions, e.g., to classify future incoming service requests. Thus, when a new data set 392 of service request(s) and/or device health data is received, the model can be used to make a prediction 394, e.g., that classifies each service request into a particular classification.

Various neural network parameters may be used to classify service requests. In some implementations, the neural network may include an input encoded layer that is to receive an encoded feature vector representing the selected (and preprocessed) features. Various numbers of hidden layers, such as two, may be provided downstream of the input encoded layer. Each hidden layer may have various numbers of units or nodes, such as 128, as well as a drop out regularizer for reducing overfitting by preventing complex co-adaptations on training data. Downstream from the hidden layers may be a classification layer, such as a softmax layer, that classifies the data into one of some finite number of classifications (or “bins”), which each classification corresponding to a type of deficiency experienced by data processing devices. The model may be optimized using techniques such as stochastic gradient descent with various loss functions (e.g., categorical cross entropy). The numbers of iterations or “epochs” may vary, and may be forty in some implementations.

Referring back to FIG. 2, in some examples, remediation system 100 may perform demand forecasting, e.g., based on device health data 242 obtained from a plurality of data processing devices 114. Based on this forecasting, remediation system 100 may provide, to remediation facilities 120_{1-N} at arrow 252, information about demand for particular components/services the facility is likely to incur in the future. This information may inform the facility 120 about hardware they should stock in their inventory 122, as well as what training or hiring of personnel 124 may be beneficial to address the future demand.

Remediation system 100 in general, and inference module 104 in particular, may make these demand forecasts using various techniques. In some implementations, various types of machine learning models, such as a neural network or a support vector machine, may be trained to predict future demand based on historical device health data (e.g., which is labeled) and/or based on historical service requests. Additional historical data may also be considered, such as what products/parts/components were in stock each day/week/month over a past time period, how often each component was replaced/repaired per time interval, etc.

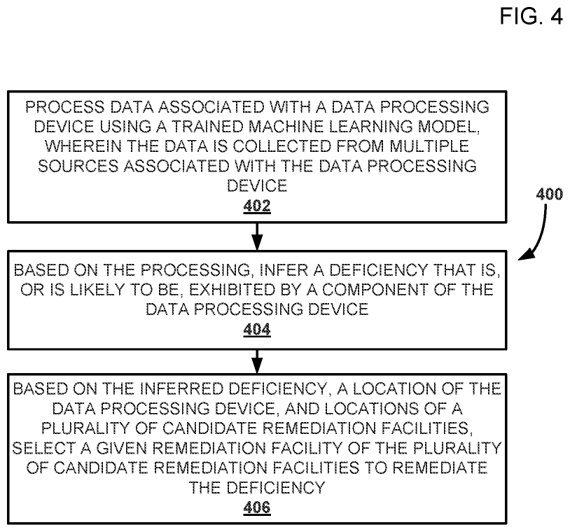

FIG. 4 depicts an example method 400 for practicing selected aspects of the present disclosure, in accordance with various examples. For convenience, the operations of method 400 will be described as being performed by a system, which may include, for instance, remediation system 100. The operations of method 400 may be reordered, and various operations may be added and/or omitted.

At block 402, the system, e.g., by way of inference module 104, may process data associated with a data processing device 114 using a trained machine learning model, such as a neural network or support vector machine. In various examples, the data may be collected from multiple sources associated with the data processing device 114, such as from a service request submitted by a user 116 of the data processing device 114, from device health data (e.g., 242) generated by data processing device 114 itself, and/or from device health data generated by other similar data processing devices, such as the same model (e.g., components of the same model of computer may tend to fail in temporal bursts or clusters).

In various examples, a service request may include natural language provided by user 116 of data processing device 114. In some examples, the processing of block 402 may include performing natural language processing on the natural language service request to assign the natural language service request one of a plurality of classifications. In block 406 below, the given remediation facility may be further selected based on the assigned classification.

Based on the processing at block 402, at block 404, the system may infer, e.g., by way of inference module 104, a deficiency that is, or is likely to be, exhibited by a component of the data processing device. For example, inference module 104 may infer that a particular component such as a battery is likely to fail in the coming weeks. In some implementations, inference module 104 may infer that a particular component of data processing device 114 is experiencing a particular deficiency currently.

Based on the inferred deficiency, a location of the data processing device, and locations of a plurality of candidate remediation facilities, at block 406, the system may select a given remediation facility 120 of the plurality of candidate remediation facilities 120_{1-N} to remediate the deficiency. In some examples, the given remediation facility 120 may be further selected based on measure(s) of expertise of personnel 124 at each of the plurality of candidate remediation facilities 120_{1-N}. If the deficiency is predicted in the future, then the selected remediation facility may receive a recommendation to stock a particular component, or may be automatically supplied with the particular component. If the deficiency is a present deficiency, then the geographically-closest remediation facility that has sufficient inventory 122 and/or personnel 124 to remediate the deficiency may be selected, even if another, less-qualified remediation facility 120 is closer to the data processing device 114 suffering the deficiency.

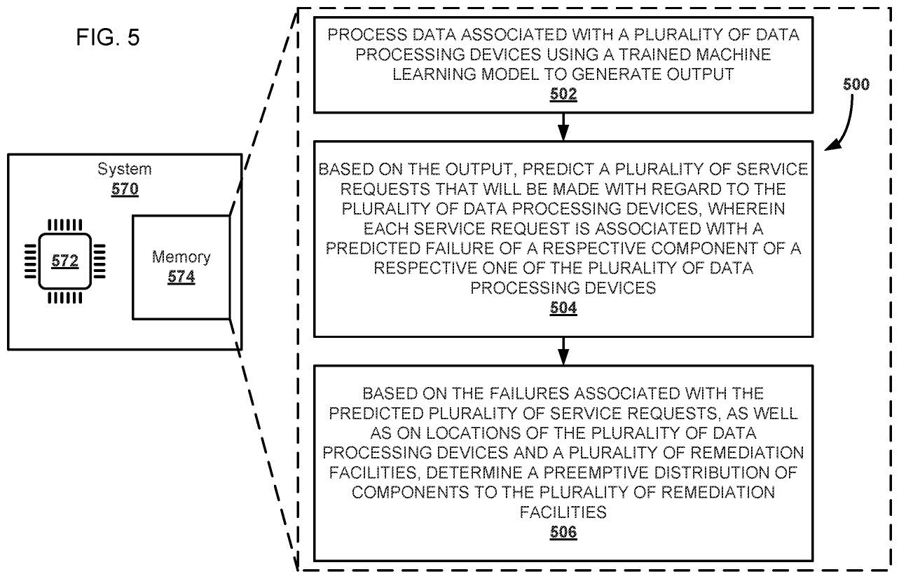

FIG. 5 shows a schematic representation of a system 570, according to an example of the present disclosure. System 570 includes a processor 572 and memory 574 that stores non-transitory computer-readable instructions 500 for performing aspects of the present disclosure, according to an example.

Instructions 502 cause processor 572 to process data associated with a plurality of data processing devices (e.g., 114A-C) using a trained machine learning model (e.g., a neural network or support vector machine) to generate output. This data may include, for instance, historical and/or recent service requests from users, and/or device health data provided automatically (e.g., periodically) by data processing devices 114.

Based on the output, instructions at block 504 may cause processor 572 to predict a plurality of service requests that will be made with regard to the plurality of data processing devices. In various examples, each service request may be associated with a predicted failure of a respective component of a respective one of the plurality of data processing devices. For example, recent device health data across a substantial portion of a particular model of computer may suggest that battery failure rates are increasing, and will likely continue to increase as time goes on.

Based on the failures associated with the predicted plurality of service requests, as well as on locations of the plurality of data processing devices and a plurality of remediation facilities, instructions at block 504 may cause processor 572 to determine a preemptive distribution of components to the plurality of remediation facilities. For example, if the computer model for which batteries are predicted to fail soon are located across specific regions (e.g., states, countries, counties, etc.), then remediation facilities within or near the same regions may be proactively stocked in order to meet this demand.

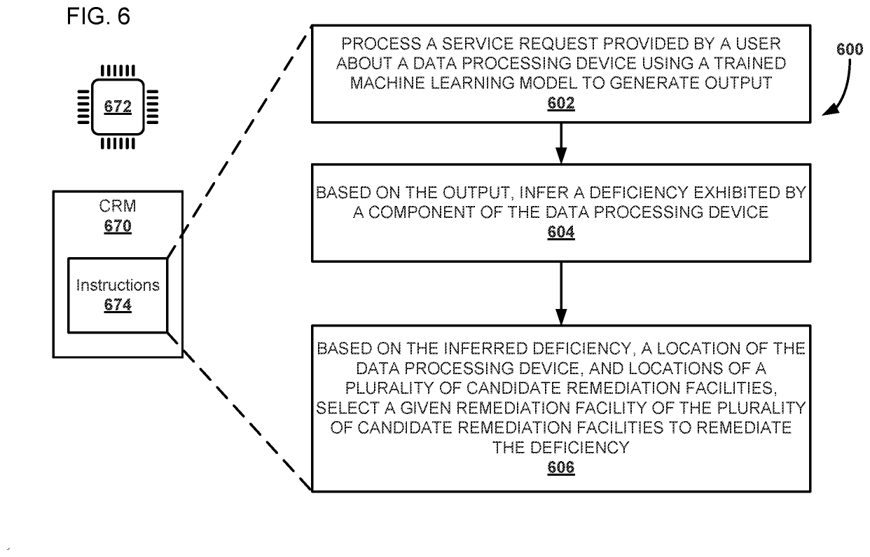

FIG. 6 shows a schematic representation of a non-transitory computer-readable medium (CRM) 672, according to an example of the present disclosure. CRM 670 stores computer-readable instructions 674 that cause the method 600 to be carried out by a processor 672.

At block 602, processor 672 may process a service request provided by a user 116 about a data processing device 114 using a trained machine learning model such as a neural network or support vector machine to generate output. Based on the output, at block 604, processor 672 (e.g., operating inference module 104) may infer a deficiency exhibited by a component of the data processing device. Based on the inferred deficiency, as well as on a location of the data processing device, and locations of a plurality of candidate remediation facilities, at block 606, processor 672 may select a given remediation facility of the plurality of candidate remediation facilities to remediate the deficiency.

Although described specifically throughout the entirety of the instant disclosure, representative examples of the present disclosure have utility over a wide range of applications, and the above discussion is not intended and should not be construed to be limiting, but is offered as an illustrative discussion of aspects of the disclosure.

What has been described and illustrated herein is an example of the disclosure along with some of its variations. The terms, descriptions and figures used herein are set forth by way of illustration and are not meant as limitations. Many variations are possible within the spirit and scope of the disclosure, which is intended to be defined by the following claims—and their equivalents—in which all terms are meant in their broadest reasonable sense unless otherwise indicated.

What is claimed is:

1. A method implemented using a processor, comprising:
processing data associated with a data processing device using a trained machine learning model, wherein the data is collected from multiple sources associated with the data processing device;
based on the processing, inferring a deficiency that is, or is likely to be, exhibited by a component of the data processing device; and
based on the inferred deficiency, a location of the data processing device, and locations of a plurality of candidate remediation facilities, selecting a given remediation facility of the plurality of candidate remediation facilities to remediate the deficiency.

2. The method of claim 1, wherein the given remediation facility is further selected based on measure(s) of expertise of personnel at each of the plurality of candidate remediation facilities for remediating the deficiency.

3. The method of claim 1, wherein the data associated with the processing device includes a natural language service request provided by a user of the data processing device.

4. The method of claim 3, wherein the processing comprises performing natural language processing on the natural language request to assign the natural language service request one of a plurality of classifications, wherein the given remediation facility is further selected based on the assigned classification.

5. The method of claim 4, wherein the given remediation facility is selected based on availability of replacement components at each of the plurality of candidate remediation facilities.

6. The method of claim 4, further comprising overriding a classification provided by the user for the natural language service request with the assigned classification.

7. The method of claim 1, wherein inferring the deficiency includes predicting that the deficiency will occur in the future, and the method includes, in response to the predicting, supplying the given remediation facility with a replacement for the component of the data processing device or another tool for remediating the deficiency in the component of the data processing device.

8. The method of claim 1, wherein the data associated with the processing device includes device health data provided by the data processing device.

9. The method of claim 1, comprising causing output to be provided to a user of the data processing device, wherein the output conveys information about the given remediation facility.

10. A system comprising a processor and memory storing instructions that, in response to execution of the instructions by the processor, cause the processor to:
process data associated with a plurality of data processing devices using a trained machine learning model to generate output;
based on the output, predict a plurality of service requests that will be made with regard to the plurality of data processing devices, wherein each service request is associated with a predicted failure of a respective component of a respective one of the plurality of data processing devices; and
based on the failures associated with the predicted plurality of service requests, as well as on locations of the plurality of data processing devices and a plurality of remediation facilities, determine a preemptive distribution of components to the plurality of remediation facilities.

11. The system of claim 10, wherein the preemptive distribution of components is determined further based on measure(s) of expertise of personnel at each of the plurality of remediation facilities.

12. The system of claim 10, comprising instructions to:
process a new service request received from a user of a given data processing device; and
based on the new service request, a location of the given data processing device, and the locations of the plurality of remediation facilities, select a given remediation facility to address the new service request.

13. The system of claim 12, wherein the given remediation facility is selected further based on measure(s) of expertise of personnel at each of the plurality of remediation facilities.

14. A non-transitory computer-readable medium comprising instructions that, in response to execution of the instructions by a processor, cause the processor to process a service request provided by a user about a data processing device using a trained machine learning model to generate output;
based on the output, infer a deficiency exhibited by a component of the data processing device; and
based on the inferred deficiency, a location of the data processing device, and locations of a plurality of candidate remediation facilities, select a given remediation facility of the plurality of candidate remediation facilities to remediate the deficiency.

15. The non-transitory computer-readable medium of claim 14, wherein the output assigns the service request to one of a plurality of classifications based on the output, wherein the given remediation facility is further selected based on the assigned classification.
